(19) United States
(12) Patent Application Publication
(10) Pub. No.: US 2007/0031808 A1
(43) Pub. Date: Feb. 8, 2007

(54) Protractile electric tombstone toy

(76) Inventor: Kuo-Jui Wei, Taipei City (TW)

Correspondence Address: PRO-TECHTOR INTERNATIONAL SERVICES, 20775 NORADA CT., SARATOGA, CA, 95070, US

(21) Appl. No.: 11/317,032

(22) Filed: Dec. 22, 2005

(30) Foreign Application Priority Data
Aug. 5, 2005 (CN) 200520111394.4

(51) Int. Cl. G09B 25/00

(52) U.S. Cl. 434/378; 434/393

(57) ABSTRACT

A protractile electric tombstone toy includes a body (10) and a power supply (100). The body (10) is hollow. A resilient cloth (20) is disposed at the front of the body (10). A protruding member (30) is disposed behind the resilient cloth. The protruding member (30) is driven by a drive module (40) to move the resilient cloth (20) to project outwardly or backwardly. After the button switch TRY-ME is turned on or a sound signal is provided, the protractile electric tombstone toy of the present invention moves the resilient cloth to project the protruding member outwardly with extra horrific sound and light, thereby having a lifelike effect.

### RELATED APPLICATIONS

The present application is based on, and claims priority from, China Application Serial Number 200520111394.4, filed Aug. 5, 2005, the disclosure of which is hereby incorporated by reference herein in its entirety.

### FIELD OF THE INVENTION

The present invention relates to a drive and control for a toy, and particularly to a drive and control for an electric tombstone toy which can make sound and emit light.

### BACKGROUND OF THE INVENTION

There are few tombstone toy disclosed in the prior art. A real tombstone is generally made of solid stone and can be improved in appearance by adding surface decoration or by dressing or shaping the stone. Chinese utility model patent application No. 00248781, entitled “a tombstone” disclosed an improved tombstone. Chinese utility model patent application No. 92223517 entitled “composite tombstone” disclosed a tombstone with an included chamber, but the chamber is only for holding a cinerary casket and cannot move.

### SUMMARY OF THE INVENTION

An object of the present invention is to provide a protractile electric tombstone toy veiled by a resilient cloth, wherein when turning on a switch or emitting a sound control signal, a protruding member moves the resilient cloth to project with spine-chilling sound and light.

To achieve the above object, a protractile electric tombstone toy of the present invention includes a body and a power supply. The body is hollow. A resilient cloth is disposed at the front of the body. A protruding member is disposed in the rear of the resilient cloth. The protruding member is driven by a drive module to project the resilient cloth outwardly or draw it backwardly.

The drive module further includes a speaker which is connected to a speaker output port of a main control chip for being controlled to create sound.

The drive module includes a first lamp group and a second lamp group, and the first and second lamp groups are respectively driven by transistors and are connected to lamp control output ports of the main control chip for being controlled to emit light.

The drive module further includes transistors and a forward and backward drive motor, wherein the forward and backward drive motor is controlled by the transistors to drive the protruding member to wholly project or wholly withdraw through a retracting and extending drive mechanism.

The drive module further includes a transistor and an open and close drive motor, wherein the open and close drive motor is controlled by the transistor to drive the lower portion of the protruding member to open and close through a forward and backward transmission mechanism.

As compared with the conventional technique, after the button switch is turned on or a sound signal is provided, the protractile electric tombstone toy of the present invention moves the resilient cloth outwardly by the protruding member while exhibiting terrifying sound and light, thereby having a lifelike effect.

These and other embodiments, aspects and features of the invention will be better understood from a detailed description of the preferred embodiments of the invention, which are further described below in conjunction with the accompanying figures.

### BRIEF DESCRIPTION OF THE DRAWINGS

FIG. 1 is an inactive schematic view of protractile electric tombstone toy of the present invention;

FIG. 2 is an activated schematic view of the protractile electric tombstone toy of the present invention;

FIG. 3 is a circuit diagram of the protractile electric tombstone toy of the present invention;

FIG. 4 is a rear view of an opening and closing lower portion of a protruding member of the protractile electric tombstone toy of the present invention; and

FIG. 5 is a schematic view showing the protruding member of the protractile electric tombstone toy of the present invention being forwardly and outwardly extended.

### DETAILED DESCRIPTION OF THE PREFERRED EMBODIMENT

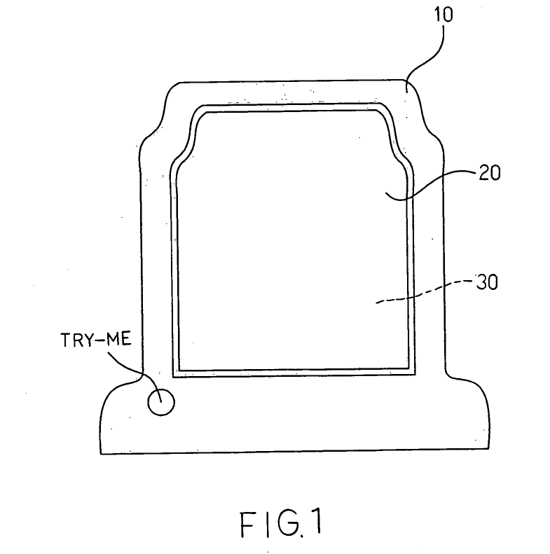

Referring to FIGS. 1-3, which show an protractile electric tombstone toy in accordance with an embodiment of the present invention, the protractile electric tombstone toy includes a body 10 and a power supply 100. The body 10 is hollow. A resilient cloth 20 is disposed at the front of the body 10. A protruding member 30 is disposed behind the resilient cloth 20. The protruding member 30 is driven by a drive module 40 to move the resilient cloth 20 to project outwardly or draw backwardly.

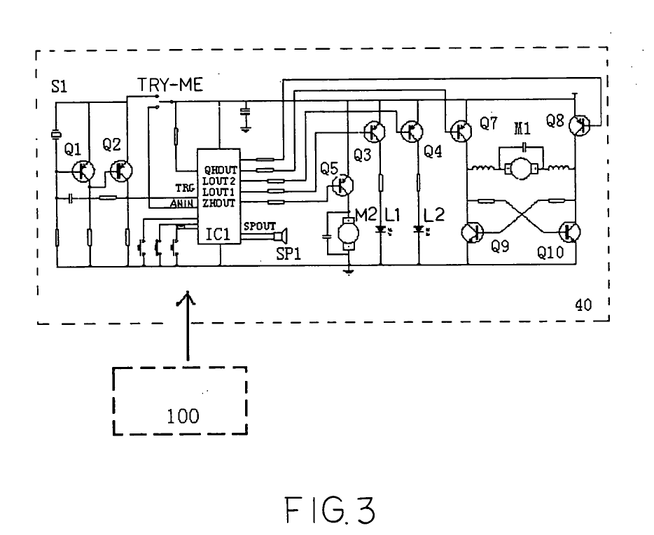

Referring to FIG. 3, the drive module 40 includes a speaker SP1, which is connected to a speaker output port SPOUT of a main control chip IC1 to control playing spine-chilling and startling sound.

The drive module 40 includes a first lamp group L1 and a second lamp group L2. The first and second lamp groups L1, L2 are respectively driven by transistors Q3, Q4 and are connected to lamp control output ports LOUT1, LOUT2 of the main control chip IC1 to control emitting light. The first and second lamp groups L1, L2 are preferably disposed at ocular positions of the surface of the protruding member 30.

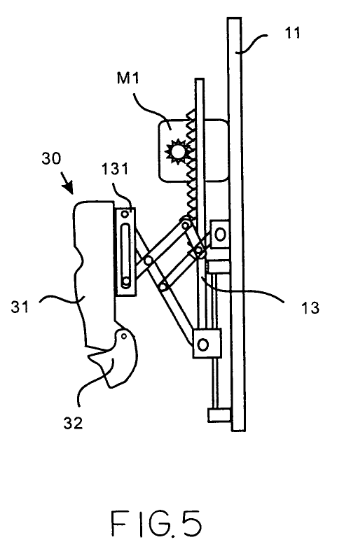

Referring to FIG. 5, the drive module 40 further includes transistors Q7˜Q10 and a forward and backward drive motor M1. The forward and backward drive motor M1 is controlled by the transistors Q7˜Q10 to drive the protruding member 30 to wholly project or draw back through a retracting and extending drive mechanism 13. Each of the drive motor M1 and the retracting and extending drive mechanism 13 has one end fixed at a housing 11. Another end of the retracting and extending drive mechanism 13 is defined with a groove 131. The groove 131 is fixed at the protruding member 30.

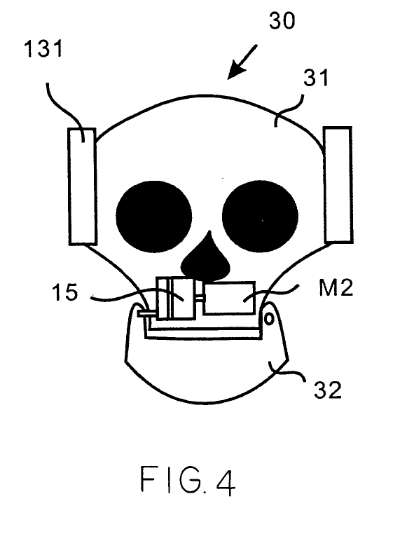

Referring to FIG. 4, the protruding member 30 includes a main portion 31 and a lower portion 32. The drive module 40 further includes an open and close drive motor M2 and a transistor Q5. The open and close drive motor M2 is controlled by the transistor Q5 to drive the lower portion 32 of the protruding member 30 to open and close through a forward and backward transmission mechanism 15. The lower portion 32 and the main portion 31 cooperatively achieve dynamic effect.

The drive module 40 includes a main control chip IC1, transistors Q1, Q2 and a sound control chip S1. The sound control chip S1 is connected between the base electrode and the emitting electrode of the transistor Q1. The base electrode of the transistor Q2 is connected to the collecting electrode of the transistor Q1. The collecting electrode of the transistor Q2 is connected to a sound control input port TRG of the main control chip IC1.

The protruding member 30 may be configured to be in a shape of a human skull, an animal head, a human head or a horrific monster.

Referring again to FIG. 3, the power supply 100 is a dry battery or a rechargeable battery for supplying power to the drive module 40. Alternatively, the power supply 100 is a direct current converted from alternating current.

The drive module 40 further includes a button switch TRY-ME. The common end of the button switch TRY-ME is connected to the positive pole of the power supply and a first control end of the button switch is connected to ANIN of the main control chip IC1.

A second control end of the button switch TRY-ME is connected to emitting electrodes of the transistors Q1, Q2 and an electrode of the sound control chip S1. That is, when the button switch TRY-ME is not selected, transistors Q1, Q2 and the sound control chip S1 form a sound control circuit which is connected to a power supply and is active. When a sound signal is received, the main control chip IC1 is triggered to enable the drive module 40 to work. When the button switch TRY-ME is selected and pushed, the main control chip IC1 is triggered directly to enable the drive module 40 to work.

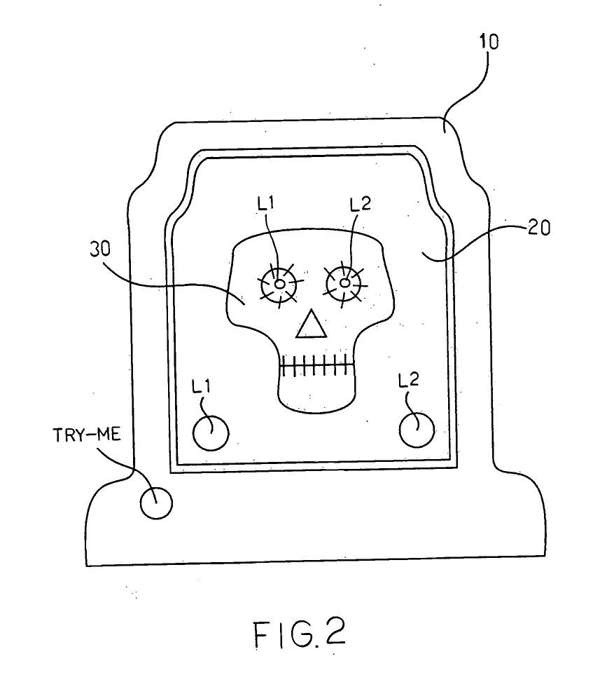

FIG. 2 shows that the protruding member 30 of the preferred embodiment is in a shape of a human skull. When the drive module 40 is triggered, the protruding member 30 projects and retreats at least once while emitting light and sound.

In the preferred embodiment, first and second lamp groups L1, L2 are disposed on the protruding member and each includes more than one LED disposed at the eye of the skull or other ocular position. Particularly, the LED disposed at the eye socket has a significantly terrifying effect when emitting light.

In other embodiments, the LEDs may be disposed at any points of the protruding member 30 behind the resilient cloth 20 so as to create an even better effect.

Hence, after the button switch is turned on or a sound signal is provided, the protractile electric tombstone toy of the present invention moves the resilient cloth to project the protruding member while emitting horrific sound and light, thereby having a lifelike effect.

The preferred embodiments, aspects, and features of the invention have been described in detail. It will be apparent to those skilled in the art that numerous variations, modifications, and substitutions may be made without departing from the spirit of the invention as disclosed and further claimed below.

What is claimed is:

1. A protractile electric tombstone toy comprising a body and a power supply, wherein the body is hollow, a resilient cloth is disposed at the front of the body, a protruding member is disposed behind the resilient cloth, and the protruding member is driven by a drive module to move the resilient cloth outwardly or draw the resilient cloth backwardly.

2. The protractile electric tombstone toy of claim 1, wherein the drive module further includes a speaker SP1, which is connected to a speaker output port SPOUT of a main control chip (IC1) for being controlled to make sound.

3. The protractile electric tombstone toy of claim 1, wherein the drive module includes a first lamp group L1 and a second lamp group L2, and the first and second lamp groups L1, L2 are respectively driven by transistors Q3, Q4 and are connected to lamp control output ports LOUT1, LOUT2 of the main control chip IC1 for being controlled to emit light.

4. The protractile electric tombstone toy of claim 1, wherein the drive module further includes a forward and backward drive motor M1 for the protruding member and transistors Q7˜Q10, wherein the forward and backward drive motor M1 is controlled by the transistors Q7˜Q10 to drive the protruding member to wholly project or retreat through a retracting and extending drive mechanism.

5. The protractile electric tombstone toy of claim 1, wherein the protruding member includes a main portion and a lower portion, the drive module further includes an open and close drive motor M2 for the protruding member and a transistor Q5, and the open and close drive motor M2 is controlled by the transistor Q5 to drive the lower portion of the protruding member to open and close through a forward and backward transmission mechanism.

6. The protractileelectric tombstone toy of claim 1, wherein the drive module includes a main control chip IC1, transistors Q1, Q2 and a sound control chip S1, the sound control chip S1 is connected between the base electrode and the emitting electrode of the transistor Q1, the base electrode of the transistor Q2 is connected to the collecting electrode of the transistor Q1, and the collecting electrode of the transistor Q2 is connected to a sound control input port TRG of the main control chip IC1.

7. The protractile electric tombstone toy of claim 1, wherein the protruding member is configured in a shape of a human skull, an animal head, a human head or a horrific monster.

8. The protractile electric tombstone toy of claim 1, wherein the power supply is a dry battery or a rechargeable battery for supplying power to the drive module.

9. The protractile electric tombstone toy of claim 1, wherein the power supply is an alternating current for supplying power to the drive module after being converted and regulated.

10. The protractile electric tombstone toy of claim 1, wherein the drive module includes a button switch TRY-ME, the common end of the button switch TRY-ME is connected to the positive pole of the power supply and a first control end of the button switch is connected to ANIN of the main control chip IC1.
